(19) United States
(12) Patent Application Publication
(10) Pub. No.: US 2025/0325982 A1
(43) Pub. Date: Oct. 23, 2025

(54) ONE-TIME-OPEN MICROFLUIDIC VALVES

(71) Applicant: Hewlett-Packard Development Company, L.P., Spring, TX (US)

(72) Inventor: Alexander Govyadinov, Corvallis, OR (US)

(73) Assignee: Hewlett-Packard Development Company, L.P., Spring, TX (US)

(21) Appl. No.: 18/868,110

(22) PCT Filed: May 26, 2022
(86) PCT No.: PCT/US2022/031098

§ 371 Date: Nov. 21, 2024

(51) Int. Cl. B01L 3/00; F16K 99/00

(52) U.S. Cl. CPC B01L 3/502738; F16K 99/0044; F16K 99/0048; B01L 2400/0406

(57) ABSTRACT

An example one-time-open microfluidic valve can include an inlet microfluidic channel in a first elevation plane and an outlet channel in a second elevation plane. An upstream end of the outlet channel can overlap a downstream end of the inlet microfluidic channel. A capillary nozzle opening can connect the inlet microfluidic channel to the outlet channel at the overlapping ends. The capillary nozzle opening can have an outlet width that is smaller than a width of the outlet channel. A fluid actuator can be positioned to eject a fluid in the inlet microfluidic channel through the capillary nozzle opening into the outlet channel.

### BACKGROUND

Microfluidics relates to the behavior, control and manipulation of fluids that are geometrically constrained to a small, typically sub-millimeter, scale. Numerous applications employ passive fluid control techniques such as capillary forces. Capillary action refers to the spontaneous wicking of fluids into narrow channels without the application of external forces. In other applications, external actuation techniques are employed for a directed transport of fluid. A variety of applications for microfluidics exist, with various applications using differing controls over fluid flow, mixing, temperature, evaporation, and so on.

### BRIEF DESCRIPTION OF THE DRAWINGS

Additional features of the disclosure will be apparent from the detailed description which follows, taken in conjunction with the accompanying drawings, which together illustrate, by way of example, features of the present technology.

FIG. 1 is a side cross-sectional view of an example one-time-open microfluidic valve in accordance with the present disclosure;

FIGS. 2A-2C are side cross-sectional views illustrating the operation of an example one-time-open microfluidic valve in accordance with the present disclosure;

FIGS. 3A-3D are top-down views of layers of solid material that can be stacked to form the one-time-open microfluidic valve of FIG. 1;

FIG. 4 is a side cross-sectional view of another example one-time-open microfluidic valve in accordance with the present disclosure;

FIG. 5 is a side cross-sectional view of another example one-time-open microfluidic valve in accordance with the present disclosure;

FIGS. 6A-6D are top-down views of layers of solid material that can be stacked to form the one-time-open microfluidic valve of FIG. 5;

FIG. 7A is a top-down schematic view of another example one-time-open microfluidic valve in accordance with the present disclosure;

FIG. 7B is a side cross-sectional view of the one-time-open microfluidic valve of FIG. 7A;

FIG. 8A is a top-down schematic view of another example one-time-open microfluidic valve in accordance with the present disclosure;

FIG. 8B is a side cross-sectional view of the one-time-open microfluidic valve of FIG. 8A;

FIG. 9 is a side cross-sectional view of another example one-time-open microfluidic valve in accordance with the present disclosure;

FIG. 10 is a side cross-sectional view of another example one-time-open microfluidic valve in accordance with the present disclosure;

FIG. 11 is a side cross-sectional view of an example microfluidic device in accordance with the present disclosure; and

FIG. 12 is a flowchart illustrating an example method of opening a one-time-open microfluidic valve in accordance with the present disclosure.

Reference will now be made to several examples that are illustrated herein, and specific language will be used herein to describe the same. It will nevertheless be understood that no limitation of the scope of the disclosure is thereby intended.

### DETAILED DESCRIPTION

The present disclosure describes one-time-open microfluidic valves. The valves can utilize a capillary nozzle opening that prevents fluid from flowing through the valve while the valve is initially in a closed state. The valve can be opened by generating a sufficient pressure in the fluid to overcome the capillary forces in the capillary nozzle opening, and to wet the interior walls of a channel downstream from the capillary break. After the channel walls on both sides of the capillary nozzle opening have been wetted with the fluid, the fluid can flow freely through the valve. The phrase “one-time-open” is used to describe these microfluidic valves because the valves remain in a “closed” state, blocking fluid flow, until the capillary force is overcome and the interior downstream channel is filled with fluid. After this, the valve is “open” and fluid can flow freely through the valve. The valve can be opened once in this way, but after the fluid has flowed into the channel downstream of the valve, the valve does not include a mechanism to subsequently stop the fluid flow. Therefore, the valves are “open-time-open” because they can be opened once and not re-closed.

In examples of the present disclosure, a one-time-open microfluidic valve includes an inlet microfluidic channel in a first elevation plane and an outlet channel in a second elevation plane. An upstream end of the outlet channel overlaps a downstream end of the inlet microfluidic channel. A capillary nozzle opening connects the inlet microfluidic channel to the outlet channel at the overlapping ends. The capillary nozzle opening has an outlet width that is smaller than a width of the outlet channel. A fluid actuator is positioned to eject a fluid in the inlet microfluidic channel through the capillary nozzle opening into the outlet channel. In some examples, the inlet microfluidic channel can be formed in a first layer of photoresist material in the first elevation plane, and the outlet channel can be formed in a second layer of photoresist material in the second elevation plane. The capillary nozzle opening can be formed in an intermediate layer of photoresist material between the first layer of photoresist material and the second layer of photoresist material. In certain examples, the outlet width of the capillary nozzle opening can be from 5 μm to 60 μm. The capillary nozzle opening can be tapered. An interior surface of the capillary nozzle can be angled at from 10° to 110° with respect to the second elevation plane. In further examples, the fluid actuator can include a thermal resistor, a piezoelectric element, a direct laser heater, an infrared heater, a focused optical heater, a focused microwave heater, an arc discharge heater, an ion beam heater, and electron beam heater, an electrostatic element, a micro-electro-mechanical-systems element, a magneto-strictive element, or a combination thereof. The fluid actuator can be located at a distance from 1 μm to 50 μm away from the capillary nozzle opening. The fluid actuator can be located on an interior surface of the inlet microfluidic channel opposite from the capillary nozzle opening. In certain examples, multiple capillary nozzle openings can connect the inlet microfluidic channel to the outlet channel.

The present disclosure also describes microfluidic devices. In one example, a microfluidic device includes a fluid reservoir and an inlet microfluidic channel in a first elevation plane connected to the fluid reservoir. An outlet channel is in a second elevation plane overlapping a portion of the inlet microfluidic channel. A capillary nozzle opening connects the inlet microfluidic channel to the outlet channel at the overlapping portion. The capillary nozzle opening has an outlet width that is smaller than a width of the outlet channel. The outlet channel does not include an additional fluid inlet upstream of the capillary nozzle opening. A fluid actuator is positioned to eject a fluid in the inlet microfluidic channel through the capillary nozzle opening into the outlet channel. In some examples, the inlet microfluidic channel can have a first flow direction upstream of the capillary nozzle opening, and the outlet channel can have a second flow direction downstream of the capillary nozzle opening, where the first flow direction and second flow direction are different. In further examples, the inlet microfluidic channel can be formed in a first layer of photoresist material in the first elevation plane, and the outlet channel can be formed in a second layer of photoresist material in the second elevation plane. The capillary nozzle opening can be formed in an intermediate layer of photoresist material between the first layer of photoresist material and the second layer of photoresist material.

The present disclosure also describes methods of opening one-time-open microfluidic valves. In one example, a method of opening a one-time-open microfluidic valve includes: priming an inlet microfluidic channel with a fluid, where the inlet microfluidic channel is in a first elevation plane; stopping the fluid at a capillary nozzle opening, where the fluid forms a meniscus at an outlet of the capillary nozzle opening, where the capillary nozzle opening connects the inlet microfluidic channel to an outlet channel in a second elevation plane; and using a fluid actuator to eject a sufficient amount of fluid through the capillary nozzle opening into the outlet channel such that the outlet of the capillary nozzle opening is surrounded by fluid so that no fluid meniscus is present at the outlet of the capillary nozzle opening. In some examples, priming the inlet microfluidic channel can be performed by capillary action. In further examples, from 1 to 50 droplets of fluid can be ejected by the fluid actuator to eject the sufficient amount of fluid to open the outlet channel for priming.

### One-Time Open Microfluidic Valves

The one-time-open microfluidic valves described herein can be particularly useful in miniaturized microfluidic devices. Microfluidic devices are widely used in life sciences and other applications. These devices typically include small microfluidic flow channels having dimensions on the μm-scale, such as channels having a width or height of less than 100 μm, or less than 50 μm, or less than 20 μm, in various examples. Microfluidic channels can be fabricated with these small dimensions using processes such as photolithography. In certain processes, a photomask can be used to expose a portion of a photoresist material to radiation (such as ultraviolet light) according to the two-dimensional pattern of the photomask. This can form a variety of small two-dimensional shapes in the photoresist material, including various arrangements of microfluidic channels. However, some components of microfluidic devices have been difficult to miniaturize. For example, active components such as pumps and valves can be particularly difficult to miniaturize. Many valve designs are too bulky to be integrated in a microfluidic device. These valves can often occupy a large parasitic volume in microfluidic devices because the volume of the valve is large compared to a total volume in the microfluidic device. Other valve designs have slow response times. Valves that included moving parts are often unreliable when miniaturized to the small size of microfluidic devices. Complex mechanical valves are also expensive to manufacture at small scales. Dynamic valves can be leaky and therefore unable to completely isolate the inlet and outlet of a microfluidic channel. Thus, designing effective, small, and affordable valves for microfluidic devices can be challenging.

The one-time-open microfluidic valves described herein can be fabricated using the same two-dimensional patterning processes used to make microfluidic channels. In some examples, the valves can be free of moving parts. Therefore, the valves can be cost-effective and may not add significantly to the cost of a microfluidic device. The size of the valves can be approximately the same as the size of microfluidic channels so that the valves do not occupy a large parasitic volume in the device. The valves can also provide total separation of fluids, without being leaky. When in the closed state, the valves can maintain a meniscus of fluid in a capillary nozzle opening. The meniscus does not proceed through the capillary nozzle opening until sufficient pressure to break the meniscus is applied to the fluid. In certain examples, the capillary nozzle opening can be formed in a layer of non-wetting material, such as fluorinated photoresist material. This can increase the retention pressure and reliability of the valve. While the valve is closed, an inlet microfluidic channel leading up to the capillary nozzle opening can be filled with the fluid, while an outlet channel downstream of the capillary nozzle opening can be dry and filled with air or another gas. Thus, the fluid is totally contained by the closed valve and prevented from flowing downstream.

Another useful feature of the one-time-open microfluidic valves described herein is the connection of microfluidic channels in different elevation planes. It is noted that the microfluidic devices described herein can operate in any orientation because the force of gravity on fluids in the devices can be negligible compared to other forces such as forces of cohesion and adhesion of the fluid and forces of pressure applied to the fluid. Accordingly, any terms used herein that imply directionality are used for convenience to describe location and orientation of structures relative to one another, and not to suggest an absolute orientation or location of the structures. Terms such as “elevation,” “upper,” “lower,” “over,” “under,” and so on, may be used to describe relative positions of structures of a microfluidic device, but the absolute positions of these structures may change if the microfluidic device is turned on its side or upside-down, etc. In some examples, the microfluidic valves described herein can be described as being in a coordinate space having an x-axis, a y-axis, and a z-axis. The x-axis and y-axis can be referred to as “horizontal” axes and the z-axis can be referred to as the “vertical” axis. In these examples, the elevation planes can be planes that are in or parallel to the x-y plane. Different elevation planes can be located at different heights on the z-axis. In certain examples, the microfluidic valves can be formed from multiple layers of material such as photoresist material. In these examples, the individual layers of material can be in different elevation planes. In the microfluidic valves described herein, the capillary nozzle opening can be located between a first and a second elevation plane. An inlet channel can be formed in the first elevation plane, and an outlet channel can be formed in the second elevation plane. The capillary nozzle opening can connect the inlet channel to the outlet channel at a point where the channels overlap. The inlet channel, outlet channel, and the capillary nozzle opening can be formed using a two-dimensional patterning process as explained above. In some examples, the elevation planes can refer to planes that extend along the two dimensions that are controllable in the two-dimensional patterning process.

Some previous microfluidic valve designs have included an inlet channel, a capillary break, and an outlet channel that are all formed in a single elevation plane. For example, in some designs these structures are all formed in a single layer of photoresist material. The capillary break in these designs can include a constriction of the microfluidic channel and a sudden increase in the cross-sectional area of the microfluidic channel after the constriction. This can cause fluid to stop flowing and to form a meniscus in the capillary break. However, it can be difficult to make consistent valves with a single-layer design because the two-dimensional patterning process may not provide good control over the shape of structures in the z-axis direction. For example, it can be difficult to manufacture valves with a consistent capillary break opening because the capillary break opening is vertically oriented along the z-axis. Small inconsistencies in the size and shape of the capillary break opening can affect the break pressure that is sufficient to push fluid through the capillary break to open the valve. In contrast, the microfluidic valves described herein include a capillary nozzle opening that is oriented along the x-y plane. Therefore, the size and shape of the opening can be reliably controlled by the two-dimensional patterning process. This can allow the microfluidic valves to be manufactured with better consistency. The microfluidic valves described herein can also occupy a smaller footprint compared to single-layer designs. In the microfluidic valves described herein, the capillary nozzle opening and a fluid actuator and portions of the inlet channel and outlet channel can all overlap in a single area with a small footprint. In the single-layer designs, the inlet channel, fluid actuator, capillary break, and outlet channel are all located in different areas of the single layer, thus occupying a larger footprint.

Additionally, the microfluidic valves described herein can provide a convenient location for turns to change a direction of fluid flow in a microfluidic device. In single-layer microfluidic devices, changing the direction of flow can be more difficult because sudden bends in a microfluidic channel can sometimes cause pinning of the fluid, meaning that the fluid stops flowing and forms a meniscus at the sudden bend. Therefore, single-layer devices are often designed with microfluidic channels that curve gradually to prevent fluid pinning. These gradually curved microfluidic channels can occupy a large footprint, making the overall microfluidic device larger. In the microfluidic valve designs described herein, the formation of a meniscus and stopping the fluid flow are intentional design features. The outlet channel can be oriented at a different angle than the inlet channel so that the direction of fluid flow changes once the valve has been opened. In some examples, the outlet channel can double back on the inlet channel, so that the direction of fluid flow is reversed after the fluid flows through the valve. This can allow microfluidic devices to be designed with high packing density, having microfluidic channels that overlap and change direction in small areas.

In some examples, the one-time-open microfluidic valves can include an inlet microfluidic channel that is designed to be self-primed by capillary action. This means that fluid can flow through the inlet microfluidic channel by capillary action, without external application of pressure, until the fluid reaches the capillary nozzle opening. As explained above, at the small scale of microfluidic channels, certain forces such as adhesive and cohesive forces of liquids can become more significant compared to larger scales. For example, the behavior of water in microfluidic channels can be largely dictated by the adhesive forces of the water adhering to hydrophilic solid surfaces, and by the cohesive forces between water molecules, which may manifest as surface tension. Because the volume of water within a small microfluidic channel can be very small, the forces of gravity on the water may be less significant or negligible compared to adhesive and cohesive forces. When the solid wall surfaces of a microfluidic channel are hydrophilic, the adhesive forces between water and the microfluidic channel walls can cause water to spontaneously flow into the microfluidic channel by capillary action. This can occur regardless of the orientation of the microfluidic device, since the force of gravity on the water may be negligible. Thus, the inlet microfluidic channels of the valves described herein can be primed by water or another fluid by capillary action. In further examples, the outlet channel can also be designed to be primed by capillary action after the valve has been opened.

Opening the one-time-open microfluidic valves can be accomplished by activating the fluid actuator, which can force fluid through the capillary nozzle opening. In some examples, the fluid actuator can be a thermal resistor that forms a vapor bubble in the fluid, although other types of fluid actuators can also be used. When a vapor is formed at or near the capillary nozzle opening, the bubble can generate a pressure higher than the retention pressure of the capillary nozzle opening. As used herein, “retention pressure” refers to a pressure that is sufficient to overcome the capillary forces holding the fluid meniscus in the capillary nozzle opening. Thus, the vapor bubble can force a droplet of fluid through the capillary nozzle opening and into the outlet channel. The droplet of fluid can wet an interior surface of the outlet channel. Once the interior surfaces of the outlet channel surrounding the capillary nozzle opening have been wetted with fluid, the meniscus in the capillary nozzle opening no longer exists and fluid can then continue to flow through the capillary nozzle opening without being stopped by the capillary nozzle opening. Depending on the volume of the droplets ejected into the outlet channel and the dimensions of the outlet channel, it may take a single droplet or multiple droplets to fully wet the interior surfaces of the outlet channel sufficient to open the valve.

Additionally, the fluid actuator and the capillary nozzle opening can function as a pump to actively drive fluid into the outlet microfluidic channel. After the valve has been opened and fluid can flow freely into the outlet channel, it may still be useful in some examples to use the fluid actuator to actively drive fluid through the capillary nozzle opening. Because of the small size of the capillary nozzle opening and the placement of the fluid actuator near the opening, fluid can preferentially flow from the inlet channel to the outlet channel when the fluid actuator is repeatedly activated. Thus, the fluid actuator can be used to pump fluid through the outlet channel after the valve has been opened.

The one-time-open microfluidic valves described herein can be formed from flat layers of a solid material, such as layers of photoresist. Any desired two-dimensional shaped features can be made by patterning and developing a layer of photoresist. This type of manufacturing process allows for a high level control over the shape of the microfluidic channels in two dimensions. However, this process does not allow full control of the shape in the third dimension, which is the height or elevation dimension (i.e., up and down). In certain examples, an inlet microfluidic channel can be formed in a first layer of photoresist material by exposing the layer to a two-dimensional pattern.

Additional layers of photoresist material can be placed over the first layer. These additional layers can include a second layer of photoresist material that has an outlet channel formed therein. An intermediate layer of photoresist material can be placed between the first and second layers. The capillary nozzle opening can be formed in the intermediate layer so that the inlet microfluidic channel is fluidly connected to the outlet channel through the capillary nozzle opening. In some cases, the intermediate layer can be made of a non-wetting material such as a fluorinated photoresist material. In further examples, additional layers of material can also be included in locations under, over, or between any of the above-mentioned layers. Some control over the shape of the microfluidic valves in the z-axis direction can be obtained by stacking layers having different two-dimensional features in this way. This can be referred to as a “2.5 dimensional process” because the process provides full control over the two-dimensional shape of features in the individual layers, and limited control over the shape of features in the z-axis direction.

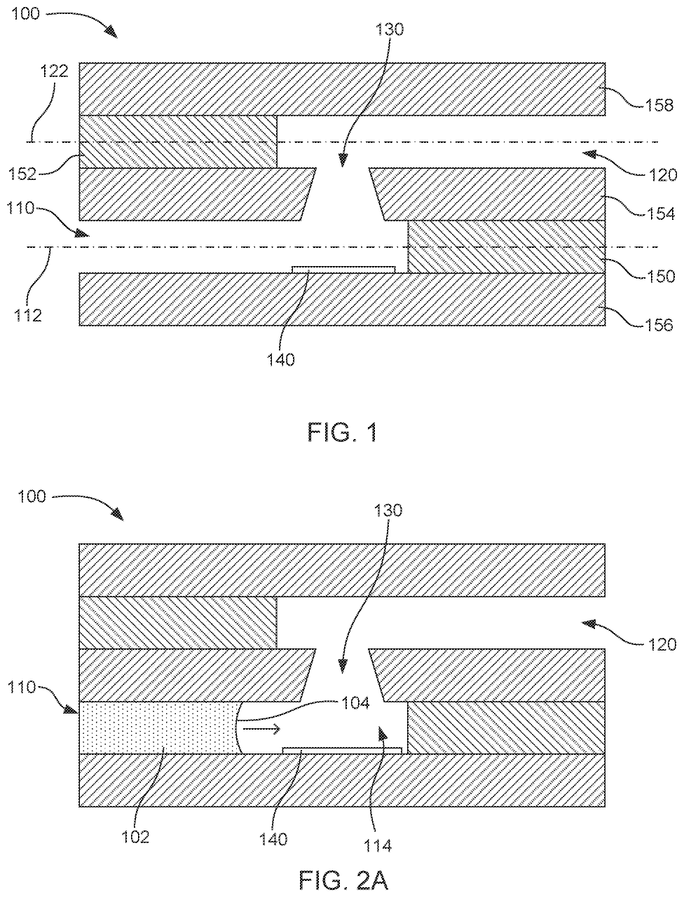

With this description in mind, FIG. 1 shows a cross-sectional side view of an example one-time-open microfluidic valve 100. The valve includes an inlet microfluidic channel 110 in a first elevation plane 112 and an outlet channel 120 in a second elevation plane 122. The outlet channel has an upstream end that overlaps a downstream end of the inlet microfluidic channel. The valve also includes a capillary nozzle opening 130 connecting the inlet microfluidic channel to the outlet channel at the overlapping ends. The capillary nozzle opening has an outlet width that is smaller than a width of the outlet channel. A fluid actuator 140 is positioned to eject fluid in the microfluidic channel through the capillary nozzle opening into the outlet channel. In this example, the fluid actuator is a thermal resistor that can be activated to generate a vapor bubble in the fluid that is in the inlet microfluidic channel. Although the inlet microfluidic channel, capillary nozzle opening, and outlet channel can be formed in various different ways, in this example these structures are formed in layers of solid photoresist material stacked one over another. The inlet microfluidic channel is formed in a first layer of photoresist material 150 in the first elevation plane. The outlet channel is formed in a second layer of photoresist material 152 in the second elevation plane. The capillary nozzle opening is formed in an intermediate layer of photoresist material 154 between the first layer and the second layer. This example also includes a substrate 156, which serves as a floor for the inlet microfluidic channel, and a top cap layer 158, which serves as a ceiling for the outlet channel.

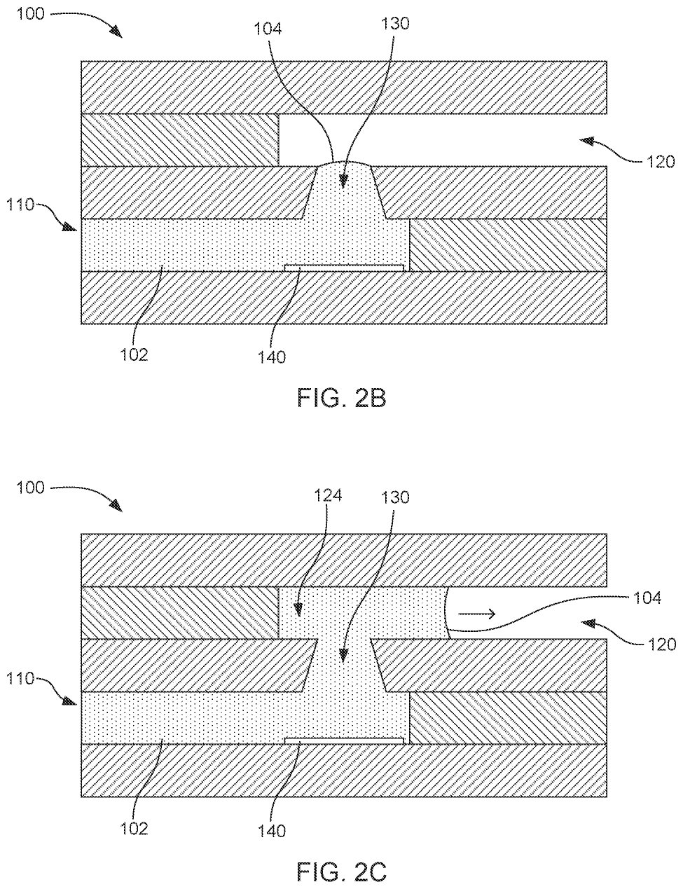

FIGS. 2A-2C illustrate the use of an example one-time-open microfluidic valve 100. As in the previous example, the valve includes an inlet microfluidic channel 110, a capillary nozzle opening 130, an outlet channel 120, and a fluid actuator 140. FIG. 2A shows a fluid 102 flowing through the inlet microfluidic channel by capillary action. The fluid has a meniscus 104 at the boundary between the fluid and air in the microfluidic channels. The meniscus is concave in FIG. 2A because the fluid has a contact angle less than 90° with the walls of the inlet microfluidic channel. This means that the adhesive forces between the fluid and the walls are sufficient to allow the fluid to flow along the inlet microfluidic channel by capillary action. In this example, the fluid can flow by capillary action to the downstream end 114 of the inlet microfluidic channel. FIG. 2B shows the valve after the fluid has filled the downstream end of the inlet microfluidic channel and the interior volume of the capillary nozzle opening. At this point, the fluid stops flowing and the meniscus is no longer concave. This is because of the sudden increase in cross-sectional area between the smaller area of the capillary nozzle opening and the larger area of the outlet channel. The fluid actuator in this example is a thermal resistor that can heat the fluid to form a vapor bubble, which increases the pressure of the fluid above the retention pressure of the capillary nozzle opening. The fluid actuator can be activated once or multiple times to drive droplets of fluid through the capillary nozzle opening. FIG. 2C shows the valve after a sufficient amount of fluid has been driven through the capillary nozzle opening to fill the upstream end 124 of the outlet channel. At this point, the meniscus is no longer in the capillary nozzle opening, but instead is in the outlet channel. The meniscus becomes concave again in the outlet channel, which means that the fluid can flow through the outlet channel by capillary action.

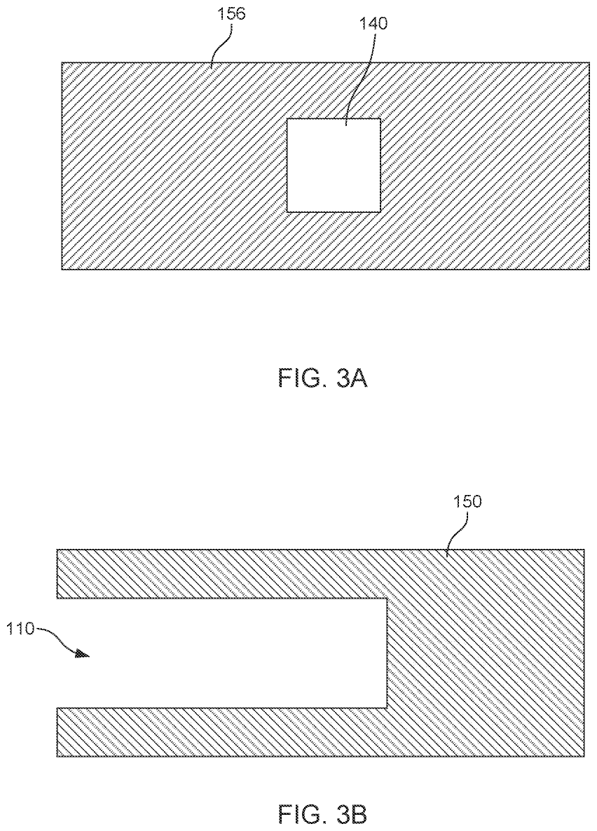

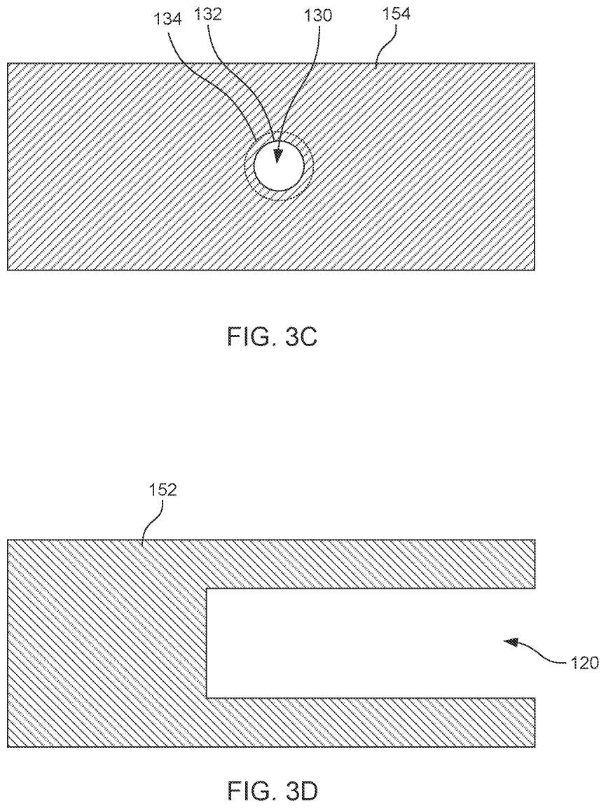

FIGS. 3A-3D show top-down views of individual layers of solid material (such as photoresist material) that can be stacked to form the example one-time-open microfluidic valve of FIG. 1. FIG. 3A shows a substrate 156, which is a continuous solid layer having a fluid actuator 140 formed thereon. The fluid actuator can be a thermal resistor in this example. A thermal resistor can include a thin layer of metal or other resistor material that is deposited on the substrate in some examples. The resistor can be connected to an electric power source through conductive traces (not shown) in some examples. Besides thermal resistors, other types of fluid actuators can include a piezoelectric element, a direct laser heater, an infrared heater, a focused optical heater, a focused microwave heater, an arc discharge heater, an ion beam heater, and electron beam heater, an electrostatic element, a micro-electro-mechanical-systems element, a magneto-strictive element, or a combination thereof. Depending on the size and operation of the specific fluid actuator, the fluid actuator can be positioned at an appropriate location to eject fluid from the inlet microfluidic channel through the capillary nozzle opening. Some fluid actuators, such as thermal resistors, can be formed on the substrate or in one of the other layers making up the microfluidic valve. Other types of fluid actuators may be too large to be positioned internally in or near the inlet microfluidic channel. These types of fluid actuators can be positioned outside the inlet microfluidic channel. In certain examples, the fluid actuator can be positioned at a distance from 1 μm to 50 μm away from the capillary nozzle opening. Specifically, this distance can be defined as the shortest distance between a point on the fluid actuator and a point in the interior volume of the capillary nozzle opening that is closest to the point on the fluid actuator. The interior volume of the capillary nozzle opening can be defined as the volume between the inlet of the capillary nozzle opening and the outlet of the capillary nozzle opening. In certain examples, the fluid actuator can be located on an interior surface of the inlet microfluidic channel opposite from the capillary nozzle opening. For example, the fluid actuator can be located on the floor of the inlet microfluidic channel, and the capillary nozzle opening can be formed in the ceiling of the inlet microfluidic channel. As explained above, the ceiling of the inlet microfluidic channel can be an intermediate layer of photoresist material that is stacked on top of a layer of photoresist material in which the inlet microfluidic channel is formed.

The substrate 156 shown in FIG. 3A can be continuous, may have fluid feed holes, or may be made without using a two-dimensional patterning process in some examples. Therefore, the substrate can be made from a variety of materials. Example substrate materials can include photoresist materials, single crystalline silicon, polycrystalline silicon, gallium arsenide, glass, silica, ceramics, semiconducting materials, polymer materials and others. In certain examples, the substrate can have a thickness from about 10 μm to about 2500 μm.

FIG. 3B shows a first layer of photoresist material 150 that has the inlet microfluidic channel 110 formed therein. As explained above, the inlet microfluidic channel can be formed using a two-dimensional patterning process. In this example, the inlet microfluidic channel is sized and shaped so that the downstream end of the inlet microfluidic channel will be aligned with and encompass the fluid actuator when the first layer of photoresist material is stacked on top of the substrate layer shown in FIG. 3A. In various examples, the inlet microfluidic channel can have a width from 10 μm to 300 μm, or from 15 μm to 200 μm, or from 20 μm to 150 μm, or from 20 μm to 100 μm, or from 10 μm to 60 μm, or from 10 μm to 40 μm. The inlet microfluidic channel can also have a height from 6 μm to 100 μm, or from 10 μm to 80 μm, or from 10 μm to 60 μm, or from 10 μm to 30 μm, or from 30 μm to 50 μm, in various examples. In certain examples, the height of the inlet microfluidic channel can be the thickness of the layer of photoresist material in which the inlet microfluidic channel is formed.

FIG. 3C shows a top-down view of an intermediate layer of photoresist material 154 that can be stacked on top of the first layer shown in FIG. 3B. A capillary nozzle opening 130 is formed in the intermediate layer. In this example, the capillary nozzle opening is tapered and has a circular shape, as a truncated cone. The capillary nozzle opening has an inlet 134 at the bottom face of the intermediate layer and an outlet 132 at the top face of the intermediate layer. The inlet is larger than the outlet. Tapering the capillary nozzle opening in this way can help increase the retention pressure of the one-time-open microfluidic valve, which can make the valve more reliable. The interior surface of the capillary nozzle opening can form an angle with the top face of the intermediate layer. This angle can also be defined as an angle with respect to the second elevation plane described above. When the capillary nozzle opening is tapered to be smaller at the outlet, the angle can be acute. More acute angles can provide higher retention pressure in some examples. However, in other examples the angle can be a right angle (90°) or an obtuse angle. In various examples, the angle can be from 10° to 110°, or from 20° to 90°, or from 30° to 85°, or from 45° to 80°, or from 60° to 80°. Tapered capillary nozzle openings can be made using photolithography processes with a variable focal plane. Light used to polymerize a photoresist material can diverge or converge at an angle, allowing an angled opening to be made of polymerized photoresist material.

The size of the capillary nozzle opening can also affect the retention pressure of the valve. The outlet of the capillary nozzle opening can have a width that is smaller than the width of the outlet channel. Thus, a fluid cross-sectional area of fluid flowing through the capillary nozzle opening can be smaller than a fluid cross-sectional area of fluid flowing into the outlet channel. The sudden increase in fluid cross-sectional area between the capillary nozzle opening and the outlet channel can cause the fluid to stop flowing by capillary action at the outlet of the capillary nozzle opening. In some examples, the outlet of the capillary nozzle opening can have a width from 5 μm to 60 μm, or from 5 μm to 40 μm, or from 5 μm to 30 μm, or from 10 μm to 25 μm. The outlet of the capillary nozzle opening can also be spaced apart from the sidewalls of the outlet channel, so that the edges of the capillary nozzle opening outlet do not contact the sidewalls of the outlet channel.

The surface energy of the intermediate layer can also affect the retention pressure of the valve. In some examples, this layer can be made from a low surface energy, non-wetting material. This can increase the contact angle between the layer material and water or aqueous fluids. Increasing the contact angle can increase the retention pressure of the valve by making it more difficult for the water or aqueous fluid to flow through the capillary nozzle opening. Examples of material that can be used to make the intermediate layer include fluorinated photoresist materials.

FIG. 3D shows a top-down view of a second layer of photoresist material 152 that can be stacked on top of the intermediate layer shown in FIG. 3C. The second layer of photoresist material has an outlet channel 120 formed therein. In some examples, the outlet channel can have any of the dimensions described above for the inlet microfluidic channel. Fluid can flow through the outlet channel by capillary action after the valve has been opened. However, in some examples the outlet channel can be larger, and may be too large for capillary flow to occur in the outlet channel. If the outlet channel is not self-primable by capillary action, then the fluid actuator can be used to actively move fluid into the outlet channel. A top cap layer can be stacked on top of the second layer of photoresist material to form a ceiling for the outlet channel. The top cap layer is not illustrated in the figure, but a simple solid continuous layer of any suitable material can be used as the top cap layer.

It is noted that in the above examples, a downstream end of the inlet microfluidic channel overlaps with an upstream end of the outlet channel.

However, in other examples the inlet microfluidic channel and the outlet channel may overlap at other places, such as at a point that is in the middle of the channels as opposed to at the downstream or upstream end of the channels. For example, the inlet microfluidic channel can overlap with a middle portion of the outlet channel. A capillary nozzle opening can be positioned at the overlap to allow fluid to flow from the inlet microfluidic channel into the outlet channel when the valve is opened. Since the capillary nozzle opening connects to a middle portion of the outlet channel in this example, the outlet channel extends in two directions from the capillary nozzle opening. In this case, fluid can flow into the outlet channel and then proceed to flow in both directions along the outlet channel. It can be useful, however, to have the overlapping portions and the capillary nozzle opening at the upstream end of the outlet channel because this can make it easier and more reliable to fill the outlet channel sufficiently to eliminate the meniscus in the capillary nozzle opening and allow fluid to flow through the valve. In some examples, the upstream end of the outlet channel can be filled with fluid by actively ejecting fluid into the outlet channel (with the fluid actuator) until the fluid extends to a point past the capillary nozzle opening. After the capillary nozzle opening has been covered by fluid, then fluid can continue to flow through the valve by capillary action.

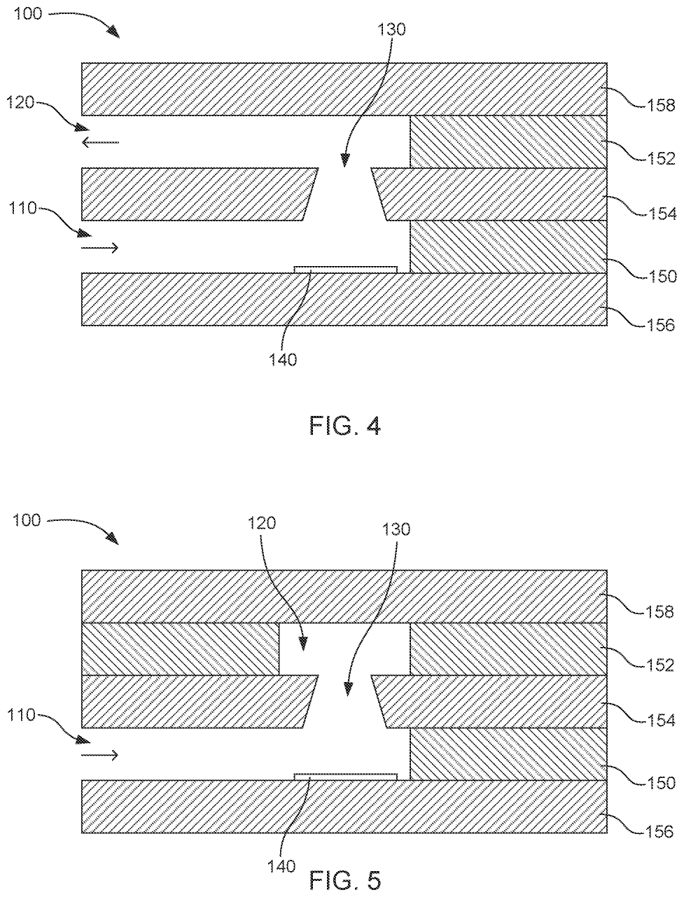

As mentioned above, the one-time-open microfluidic valves described herein can provide a convenient place for sharp bends that change the direction of flow in a microfluidic device. FIG. 4 shows a side cross-sectional view of an example one-time-open microfluidic valve 100 that allows fluid to turn 180° and flow back in the opposite direction from the inlet direction when the valve is opened. This example includes an inlet microfluidic channel 110 in which fluid flows in from the left side. The fluid reaches a capillary nozzle opening 130 and a fluid actuator 140, and then the flow of fluid is stopped by the capillary nozzle opening. When the fluid actuator is activated to eject a sufficient amount of fluid into the outlet channel 120, the fluid can continue to flow through the outlet channel. In this example, the outlet channel leads in the opposite direction to the inlet channel, and the outlet channel extends back directly over the top of the inlet channel. As in previous examples, this one-time-open microfluidic valves includes a substrate 156, a first layer of photoresist material 150, an intermediate layer of photoresist material 154, a second layer of photoresist material 152, and a top cap layer 158.

FIG. 5 shows a side cross-sectional view of another example one-time-use microfluidic valve 100. This valve design allows fluid to bend at a 90° angle when viewed from the top and proceed in the new direction 90° off of the inlet direction after the valve has been opened. This example includes an inlet microfluidic channel 110 coming in from the left side. Fluid can flow by capillary action through the inlet microfluidic channel to the capillary nozzle opening 130 and the fluid actuator 140. An outlet channel 120 is positioned above the capillary nozzle opening. The outlet channel extends in a direction 90° off of the inlet microfluidic channel. Because this is a side cross-sectional view, a cross-section of the outlet channel is visible and the outlet channel extends in the viewing direction, “into the page.”

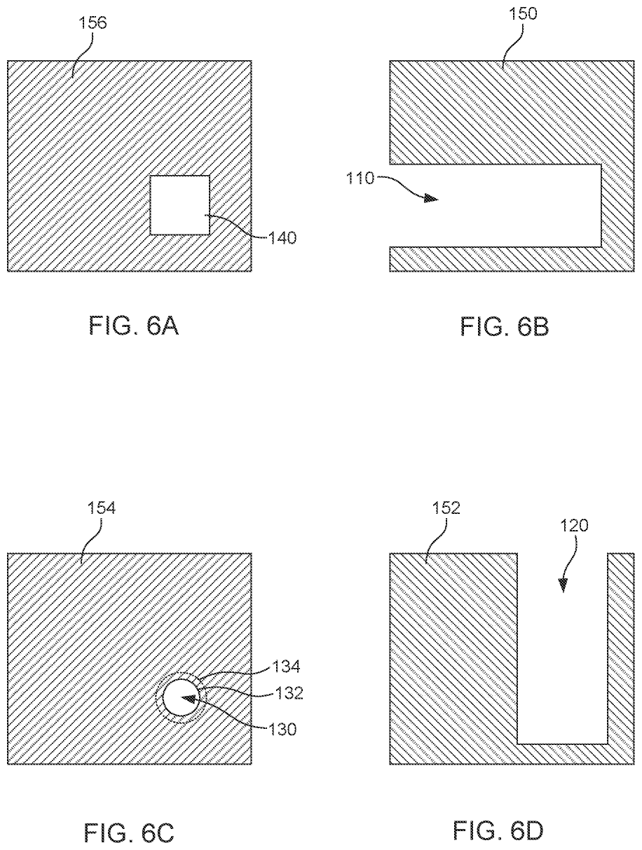

FIGS. 6A-6D are top-down views of individual layers of a similar example one-time-open microfluidic valve, in which fluid can turn at a 90° angle when the valve is opened. FIG. 6A shows a substrate 156 that has a fluid actuator 140 deposited on the substrate. FIG. 6B shows a first layer of photoresist material 150 that includes an inlet microfluidic channel that is shaped and positioned to overlap the fluid actuator at the downstream end. FIG. 6C shows an intermediate layer of photoresist material 154 that includes a capillary nozzle opening 130 positioned to overlap with the downstream end of the inlet microfluidic channel and the fluid actuator. The capillary nozzle opening has a tapered circular shape, with an inlet 134 and an outlet 132, where the inlet is larger than the outlet. FIG. 6D shows a second layer of photoresist material 152 that can be stacked on top of the intermediate layer. An outlet channel 120 is formed in the second layer of photoresist material. An upstream end of the outlet channel overlaps with the capillary nozzle opening. The outlet channel leads in a direction that is 90° off of the direction of the inlet channel.

The examples shown above have included a single capillary nozzle opening and a single fluid actuator. However, various combinations of multiple capillary nozzle openings and/or multiple fluid actuators can also be used in a single valve. As explained above, the size of the capillary nozzle opening can affect the retention pressure of the valve. Decreasing the size of the opening can increase the retention pressure of the valve, but this can also increase the pressure drop of the valve that resists flow fluid after the valve has opened. In some examples, a valve can include multiple small-sized capillary nozzle openings. The small size of the capillary nozzle openings can provide a high retention pressure, but including multiple capillary nozzle openings can allow more fluid to flow through after the valve has opened, thus reducing the pressure drop of the valve. The multiple capillary nozzle openings can be arranged in a row that is parallel to the inlet microfluidic channel, or in a row that is perpendicular to the inlet microfluidic channel, or in an array, or in any other suitable arrangement. Additionally, when multiple capillary nozzle openings are used, the valve can include multiple fluid actuators to drive fluid through the capillary nozzle openings, or a single fluid actuator to drive fluid through all of the capillary nozzle openings.

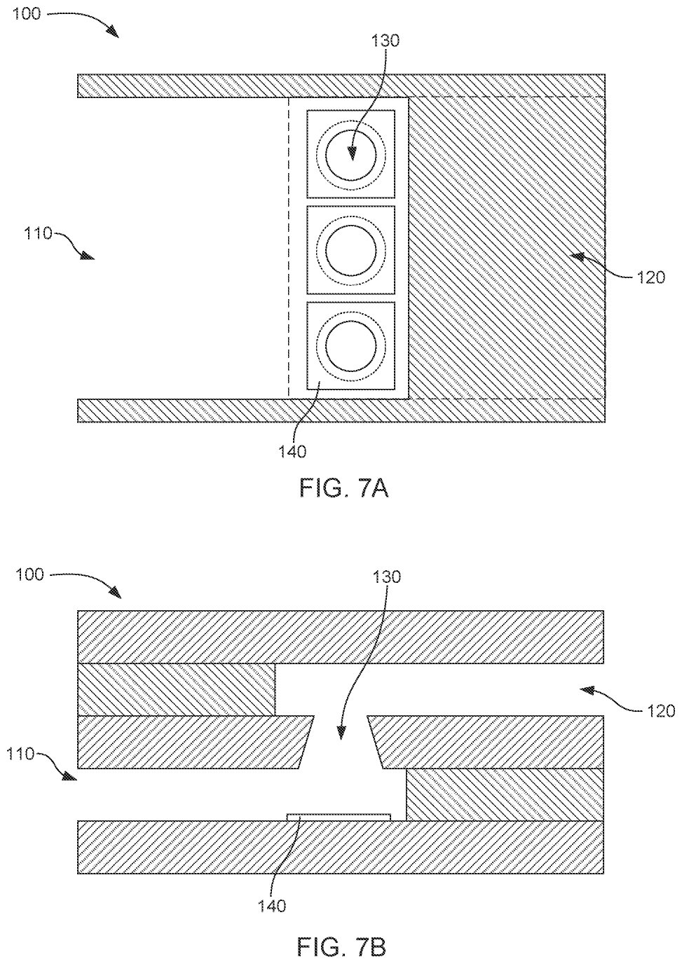

FIG. 7A is a schematic top-down view, and FIG. 7B is a cross-sectional side view, of an example one-time-open microfluidic valve 100 that includes three capillary nozzle openings 130 arranged in a row perpendicular to the inlet microfluidic channel 110. In this example, three fluid actuators 140 are positioned under the three capillary nozzle openings. The capillary nozzle openings connect to an outlet channel 120 (represented by dashed lines in FIG. 7A) that extends in the same flow direction as the inlet microfluidic channel.

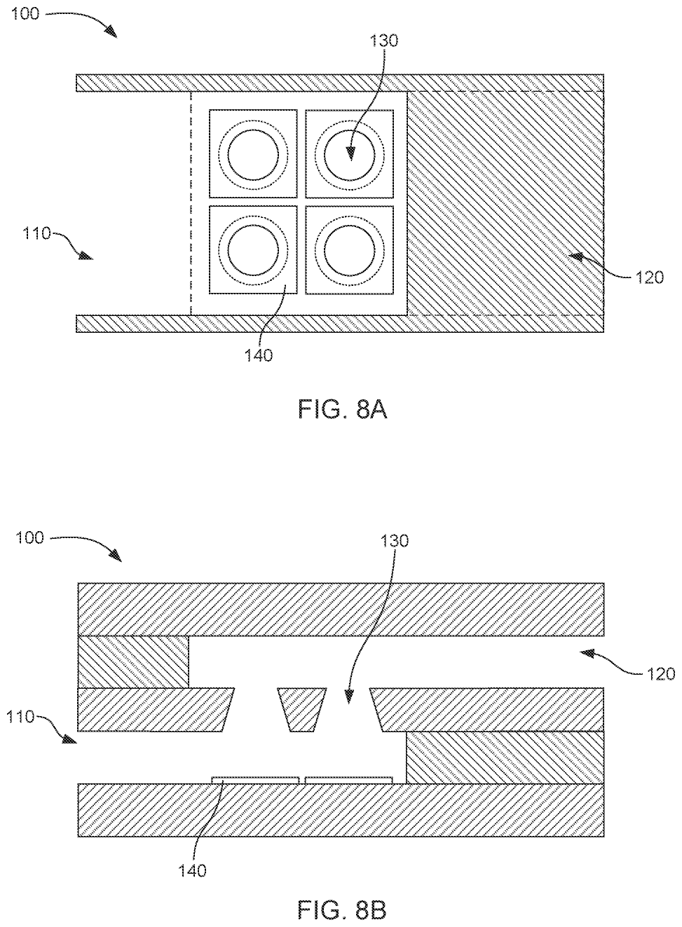

FIG. 8A is a schematic top-down view, and FIG. 8B is a cross-sectional side view, of another example one-time-open microfluidic valve 100 that includes four capillary nozzle openings 130. In this example, the capillary nozzle openings are arranged in a two-by-two array. A single large fluid actuator 140 is positioned under the array of capillary nozzle openings. The capillary nozzle openings connect an inlet microfluidic channel 110 to an outlet channel 120 as in the previous examples. Including multiple capillary nozzle openings as in these examples can allow for a higher throughput of fluid after the valve is opened, while still having a high retention pressure to be overcome in order to open the valve.

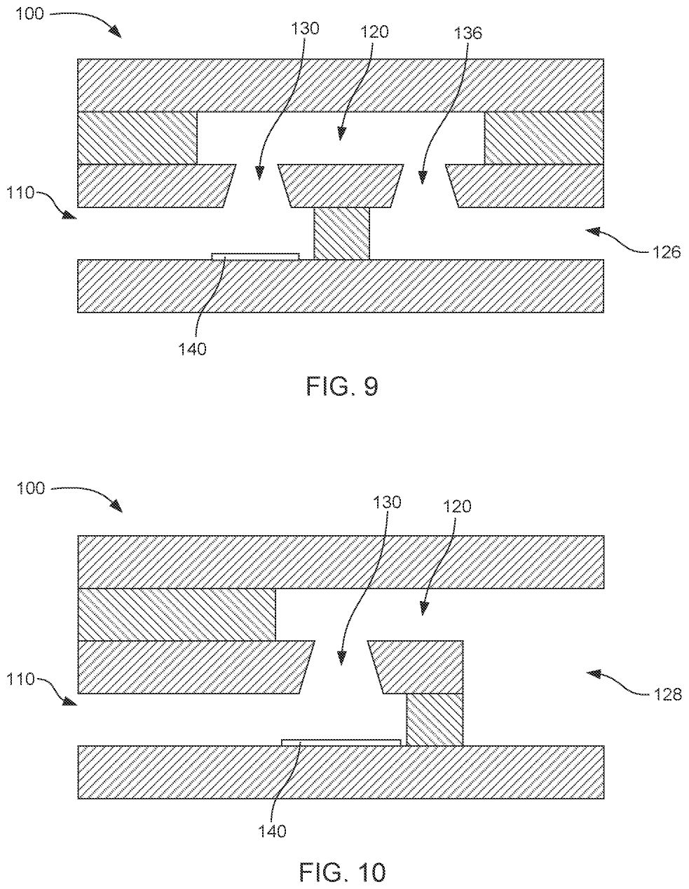

One-time-open microfluidic valves can also be made with a variety of other designs, including different geometries for the inlet microfluidic channel and the outlet channel. FIG. 9 is a side cross-sectional view of another example one-time-open microfluidic valve 100. This design includes an inlet microfluidic channel 110 leading to a capillary nozzle opening 130 and a fluid actuator 140 as in previous examples. The outlet channel 120 in this design is shortened and leads to a second nozzle opening 136, and the second nozzle is connected to a secondary outlet channel 126. In this example, the first outlet channel acts as an overpass through which fluid flows and then quickly drops back down to the lower elevation plane. This design can be useful if it desired to have the fluid flow in the first elevation plane after passing through the valve. The second nozzle opening can be manufactured using the same processes as the first capillary nozzle opening. In some cases, fluid can flow by capillary action through the second nozzle opening and into the secondary outlet channel. This can occur because the second nozzle opening is not tapered to a narrower width at its outlet like the first capillary nozzle opening. Instead, the secondary nozzle opening angles outward at its outlet, which provides a more gradual change in the cross-sectional area of fluid flowing through the second nozzle opening.

FIG. 10 shows a cross-sectional side view of another example one-time-open microfluidic valve 100. This example also includes an inlet microfluidic channel 110 leading to a capillary nozzle opening 130 and a fluid actuator 140 as in previous examples. The capillary nozzle opening is connected to an outlet channel 120. As in previous examples, the inlet channel is in one elevation plane and the outlet channel is in a different elevation plane. However, the outlet channel in this example expands into an expanded outlet channel 128 that is taller and occupies both the first elevation plane and the second elevation plane. In various examples, the outlet channel can expand in the vertical and/or horizontal directions downstream of the capillary nozzle opening. In other examples, the outlet channel can become narrower in the horizontal and/or vertical direction. The inlet microfluidic channel can also expand or become narrower in the vertical and/or horizontal directions before the inlet microfluidic channel reaches the capillary nozzle opening.

In certain examples, the one-time-open microfluidic valves described herein can be designed to be manufactured using a two-dimensional patterning process on individual layers of solid material. Depending on the process, the individual layers can be formed separately and then stacked, or one layer can be formed directly on another layer that has already been formed. Although photoresist material is an example described herein, other solid materials can also be used to make the microfluidic valves. In particular, materials that can be shaped using a two-dimensional process can be useful.

The examples described above have referred to individual layers of solid material that have various microfluidic features formed therein, and the layers can be “stacked” to form the microfluidic valves. In some examples, the layers can initially be formed as individual layers of solid material and portions of the layers can be removed to form microfluidic channels. The layers can then be stacked together and adhered together by curing, or by adhesive, or by fusing, or some other method. However, in other examples, the layers may not be formed as individual solid layers before being stacked together in this way. For example, a liquid photoresist material can be spread in a layer and then patterned and developed to form a solid layer having any desired microfluidic features formed therein. Another layer of liquid photoresist material can then be spread on the first layer, and the process of patterning and developing can be repeated to form additional layers. Thus, the layers can be formed one on top of another. In further examples, combinations of curable liquid material and solid material can be used. A variety of methods can be used to deposit layers of liquid photoresist material, such as spin coating, casting, spray coating, dip coating, and others.

In some examples, any of the layers of the one-time-open microfluidic valves can be formed from a photoresist such as SU-8 or SU-8 2000 photoresist, which are epoxy-based negative photoresists. Specifically, SU-8 and SU-8 200 are Bisphenol A Novolac epoxy-based photoresists that are available from various sources, including MicroChem Corp. These materials can be exposed to UV light to become crosslinked, while portions that are unexposed remain soluble in a solvent and can be washed away to leave voids.

In some examples, the one-time-open microfluidic valves can be formed on a substrate such as a silicon material. For example, the substrate can be formed of single crystalline silicon, polycrystalline silicon, gallium arsenide, glass, silica, ceramics or a semiconducting material. In a particular example, the substrate can have a thickness from about 500 μm to about 1200 μm.

In further examples, a primer layer can be deposited on the substrate before a first layer of solid material to form the microfluidic valves described herein. In certain examples, the primer layer can be a layer of a photoresist material, such as SU-8, with a thickness from about 2 μm to about 100 μm.

The lower layer of solid material, intermediate layer of solid material, upper layer of solid material, and any other layers of solid material in the microfluidic valves can be formed by exposing a layer of photoresist with a pattern to define the microfluidic channels, capillary nozzle openings, and other microfluidic features described above. The unexposed photoresist can then be washed away. In some examples, the layers can have a thickness from 2 μm to 100 μm. Thus, the microfluidic channel segments can have a height from 2 μm to 100 μm. In further examples, the microfluidic channel segments can have a height from 6 μm to 60 μm, or from 10 μm to 50 μm, or from 14 μm to 40 μm. In certain examples, layers of the microfluidic valves can be formed by laminating a dry film photoresist over the layer below and then exposing the dry film photoresist with a UV pattern defining any microfluidic features to be formed in that layer. In further examples, an additional ceiling or cap layer can be laminated over the top of the upper layer, forming a ceiling for the microfluidic valve.

### Microfluidic Devices

The present disclosure also discloses microfluidic devices that can include a one-time-open microfluidic valve as described herein. The microfluidic devices can include a fluid reservoir connected to the inlet microfluidic channel of the one-time-open microfluidic valve. Thus, fluid from the fluid reservoir can flow by capillary action through the inlet microfluidic channel. The fluid can then stop at the capillary nozzle opening until the valve is opened. The capillary nozzle opening can be connected to an outlet channel. In some examples, the outlet channel can have no other fluid inlet upstream of the capillary nozzle opening. Thus, any fluid flowing in the outlet channel at the location of the capillary nozzle opening can be fluid that flows from the inlet microfluidic channel through the capillary nozzle opening into the outlet channel.

The fluid reservoir can be fluidly connected to the inlet microfluidic channel in any suitable way. In some cases, the fluid reservoir can be formed in the same layer of photoresist material that the inlet microfluidic channel is formed in, and the inlet microfluidic channel can connect directly to the fluid reservoir. In other examples, the fluid reservoir can be a structure separate from the layers of photoresist material used to form the valves described herein. In certain examples, the fluid reservoir can connect to the inlet microfluidic channel through a fluid feed hole formed in the substrate. The outlet channel can also lead to a fluid hole through the substrate in some examples. Thus, fluid can pass back and forth through the substrate to the microfluidic valve, depending on the design of the microfluidic device.

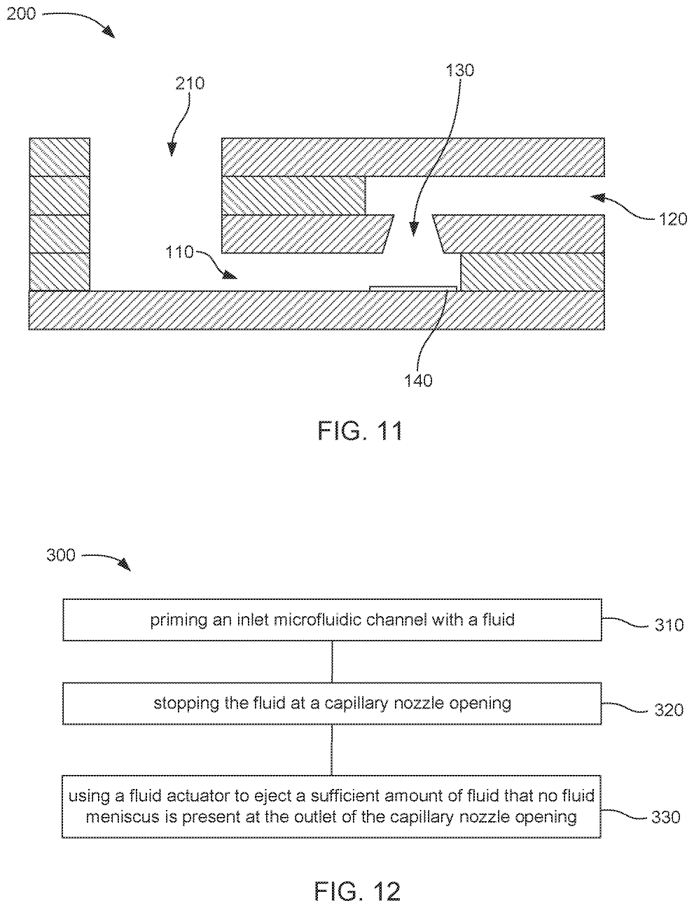

FIG. 11 shows an example microfluidic device 200. This device includes a fluid reservoir 210 that is open on the top to allow the reservoir to be filled with fluid. In other examples, fluid reservoirs can be enclosed. An inlet microfluidic channel 110 in a first elevation plane is connected to the fluid reservoir. The inlet microfluidic channel leads to a capillary nozzle opening 130 and a fluid actuator 140. As in previous examples, the capillary nozzle opening has a tapered shape. The capillary nozzle opening leads to an outlet channel 120, and the outlet of the capillary nozzle opening has a width that is less than the width of the outlet channel. The upstream end of the outlet channel overlaps with the downstream end of the inlet microfluidic channel as in previous examples.

In other examples, any of the features and components of the one-time-open microfluidic valves described above can be included in a microfluidic device. For example, the microfluidic device can include multiple capillary nozzle openings and/or multiple fluid actuators. The inlet microfluidic channel can have the same flow direction as the outlet channel, or the directions can be different. In certain examples, the outlet channel can be at an angle of 180° or 90° or another angle with respect to the inlet microfluidic channel. Microfluidic devices can also include multiple different microfluidic channels and multiple one-time-open valves connected to the different microfluidic channels. A variety of complex designs can be made using many microfluidic channels and valves.

### Methods of Opening a One-time-open Microfluidic Valve

The present disclosure also describes methods of opening one-time-open microfluidic valves. FIG. 12 is a flowchart illustrating one example method 300 of opening a one-time-open microfluidic valve. This method includes: priming an inlet microfluidic channel with a fluid, wherein the inlet microfluidic channel is in a first elevation plane 310; stopping the fluid at a capillary nozzle opening, wherein the fluid forms a meniscus at an outlet of the capillary nozzle opening, wherein the capillary nozzle opening connects the inlet microfluidic channel to an outlet channel in a second elevation plane 320; and using a fluid actuator to eject a sufficient amount of fluid through the capillary nozzle opening into the outlet channel such that the outlet of the capillary nozzle opening is surrounded by fluid so that no fluid meniscus is present at the outlet of the capillary nozzle opening 330.

As explained above, the one-time-open microfluidic valves described herein can remain closed as long as a fluid meniscus is held in the capillary nozzle opening. The meniscus is held in the capillary nozzle opening by cohesive forces in the fluid until a pressure is applied to the fluid that overcomes the retention pressure of the valve. In some examples, the inlet microfluidic channel can be primed by capillary action, meaning that fluid flows through the inlet microfluidic channel under capillary forces without any external application of pressure to the fluid. The valve can be opened by ejecting fluid through the capillary nozzle opening into the outlet channel until a sufficient amount of fluid surrounds the outlet of the capillary nozzle opening so that there is no longer a meniscus in the capillary nozzle opening. Depending on the size of the outlet channel, different amounts of fluid can be ejected into the outlet channel to open the valve. In some examples, the valve can be opened by ejecting from 1 to 50 droplets of fluid into the outlet channel. In certain examples, fluid can continue to flow through the outlet channel by capillary action after the valve has been opened. In other examples, the fluid actuator can be used as a pump to drive additional fluid through the outlet channel. Alternatively, the microfluidic device can include another pump to drive fluid through the valve and through the outlet channel.

It is to be understood that this disclosure is not limited to the particular processes and materials disclosed herein because such processes and materials may vary somewhat. It is also to be understood that the terminology used herein is used for the purpose of describing particular examples. The terms are not intended to be limiting because the scope of the present disclosure is intended to be limited by the appended claims and equivalents thereof.

### Definitions

It is noted that, as used in this specification and the appended claims, the singular forms “a,” “an,” and “the” include plural referents unless the context clearly dictates otherwise.

As used herein, the term “substantial” or “substantially” when used in reference to a quantity or amount of a material, or a specific characteristic thereof, refers to an amount that is sufficient to provide an effect that the material or characteristic was intended to provide. The exact degree of deviation allowable may in some cases depend on the specific context.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though members of the list are individually identified as a separate and unique members. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include the numerical values explicitly recited as the limits of the range, and also to include individual numerical values or sub-ranges encompassed within that range as if the numerical values and sub-ranges are explicitly recited. As an illustration, a numerical range of “about 1 wt % to about 5 wt %” should be interpreted to include the explicitly recited values of about 1 wt % to about 5 wt %, and also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

### EXAMPLES

### Example 1—Single Nozzle One-Time-Open Microfluidic Valve

An example one-time-open microfluidic valve was made with a capillary nozzle opening connected to an inlet microfluidic channel, with a thermal resistor positioned in the inlet microfluidic channel to generate vapor bubbles to eject droplets of fluid through the capillary nozzle opening. The fluid used in this example was black ink. A glass slide was placed over the capillary nozzle opening, with a spacing of 150 μm away from the capillary nozzle opening. The space between the glass slide and the capillary nozzle opening was defined as the outlet channel.

The thermal resistor was activated at a low frequency of 50 Hz to eject 50 droplets of ink. The individual droplets weighed 6 ng. The droplets of ink filled the space between the glass slide and the capillary nozzle opening. After the space had been filled, there was no longer a retention pressure holding the fluid in the capillary nozzle openings and fluid could flow freely through the capillary nozzle opening into the outlet channel.

### Example 2—Multi-Nozzle One-Time-Open Microfluidic Valve

Another example was performed using an inlet microfluidic channel that was connected to multiple capillary nozzle openings. Thermal resistors were also placed near the individual capillary nozzle openings to eject droplets of fluid through the openings. As in the previous example, the fluid used was black ink. A glass slide was placed over the capillary nozzle openings at a distance of 180 μm. Droplets of black ink were then jetted from the capillary nozzle openings until the space between the glass slide and the capillary nozzle openings was filled with ink. After this, ink could flow freely from the capillary nozzle openings into the outlet channel.

While the present technology has been described with reference to certain examples, various modifications, changes, omissions, and substitutions can be made without departing from the disclosure. It is intended, therefore, that the disclosure be limited by the scope of the following claims.

1. A one-time-open microfluidic valve, comprising:
an inlet microfluidic channel in a first elevation plane;
an outlet channel in a second elevation plane, wherein an upstream end of the outlet channel overlaps a downstream end of the inlet microfluidic channel;
a capillary nozzle opening connecting the inlet microfluidic channel to the outlet channel at the overlapping ends, wherein the capillary nozzle opening has an outlet width that is smaller than a width of the outlet channel; and
a fluid actuator positioned to eject a fluid in the inlet microfluidic channel through the capillary nozzle opening into the outlet channel.

2. The one-time-open microfluidic valve of claim 1, wherein the inlet microfluidic channel is formed in a first layer of photoresist material in the first elevation plane, wherein the outlet channel is formed in a second layer of photoresist material in the second elevation plane, and wherein the capillary nozzle opening is formed in an intermediate layer of photoresist material between the first layer of photoresist material and the second layer of photoresist material.

3. The one-time-open microfluidic valve of claim 1, wherein the outlet width of the capillary nozzle opening is from 5 μm to 60 μm.

4. The one-time-open microfluidic valve of claim 1, wherein the capillary nozzle opening is tapered.

5. The one-time-open microfluidic valve of claim 4, wherein an interior surface of the capillary nozzle is angled at from 10° to 110° with respect to the second elevation plane.

6. The one-time-open microfluidic valve of claim 1, wherein the fluid actuator comprises a thermal resistor, a piezoelectric element, a direct laser heater, an infrared heater, a focused optical heater, a focused microwave heater, an arc discharge heater, an ion beam heater, and electron beam heater, an electrostatic element, a micro-electro-mechanical-systems element, a magneto-strictive element, or a combination thereof.

7. The one-time-open microfluidic valve of claim 1, wherein the fluid actuator is located at a distance from 1 μm to 50 μm away from the capillary nozzle opening.

8. The one-time-open microfluidic valve of claim 1, wherein the fluid actuator is located on an interior surface of the inlet microfluidic channel opposite from the capillary nozzle opening.

9. The one-time-open microfluidic valve of claim 1, comprising multiple capillary nozzle openings connecting the inlet microfluidic channel to the outlet channel.

10. A microfluidic device, comprising:
a fluid reservoir;
an inlet microfluidic channel in a first elevation plane connected to the fluid reservoir;
an outlet channel in a second elevation plane overlapping a portion of the inlet microfluidic channel;
a capillary nozzle opening connecting the inlet microfluidic channel to the outlet channel at the overlapping portion, wherein the capillary nozzle opening has an outlet width that is smaller than a width of the outlet channel, wherein the outlet channel does not comprise an additional fluid inlet upstream of the capillary nozzle opening; and
a fluid actuator positioned to eject a fluid in the inlet microfluidic channel through the capillary nozzle opening into the outlet channel.

11. The microfluidic device of claim 10, wherein the inlet microfluidic channel has a first flow direction upstream of the capillary nozzle opening, wherein the outlet channel has a second flow direction downstream of the capillary nozzle opening, and wherein the first flow direction and second flow direction are different.

12. The microfluidic device of claim 10, wherein the inlet microfluidic channel is formed in a first layer of photoresist material in the first elevation plane, wherein the outlet channel is formed in a second layer of photoresist material in the second elevation plane, and wherein the capillary nozzle opening is formed in an intermediate layer of photoresist material between the first layer of photoresist material and the second layer of photoresist material.

13. A method of opening a one-time-open microfluidic valve, comprising:
priming an inlet microfluidic channel with a fluid, wherein the inlet microfluidic channel is in a first elevation plane;
stopping the fluid at a capillary nozzle opening, wherein the fluid forms a meniscus at an outlet of the capillary nozzle opening, wherein the capillary nozzle opening connects the inlet microfluidic channel to an outlet channel in a second elevation plane; and
using a fluid actuator to eject a sufficient amount of fluid through the capillary nozzle opening into the outlet channel such that the outlet of the capillary nozzle opening is surrounded by fluid so that no fluid meniscus is present at the outlet of the capillary nozzle opening.

14. The method of claim 13, wherein priming the inlet microfluidic channel is performed by capillary action.

15. The method of claim 13, wherein from 1 to 50 droplets of fluid are ejected by the fluid actuator to eject the sufficient amount of fluid.
